(19) United States
(12) Patent Application Publication
(10) Pub. No.: US 2013/0125645 A1
(43) Pub. Date: May 23, 2013

(54) FLEXIBLE FLUID LEVEL SENSOR

(71) Applicant: Joel R. BAHNER, Daytona Beach, FL (US)

(72) Inventor: Joel R. BAHNER, Daytona Beach, FL (US)

(21) Appl. No.: 13/300,719

(22) Filed: Nov. 21, 2011

(51) Int. Cl. G01F 23/26

(52) U.S. Cl. 73/304 C

(57) ABSTRACT

A capacitance fluid level sensor constructed with an elongate probe element, the probe element consisting of two concentrically positioned coil springs separated by insulators. The probe elements are deformable to facilitate placement of the fuel probe in a vessel of fluid to be measured.

### RELATED U.S. APPLICATION DATA

This application claims the benefit of U.S. Provisional Application No. 61/432,307, filed Jan. 13, 2011.

### FIELD OF THE INVENTION

The present invention pertains to transducers used for fluid measurement, and more particularly to flexible fluid level sensors utilizing variable capacitance circuitry.

### BACKGROUND

There are a wide variety of applications for the measurement of fluid levels in a container, and remote presentation of such fluid levels on a gauge or similar indicator. Typical examples are found in motor vehicle fuel measurement applications, where the level of fuel in a vehicle fuel tank is measured and displayed on an analog or digital fuel gauge, or wherein data regarding fuel level is provided in digital form to an electronic processing and display circuit, such as the type of circuit used to drive solid state multi-function displays.

Similar fluid level sensing devices may be used in conjunction with other fluids, such as oil or water, and fluid level sensors have further application in diverse environments, such as measuring the depth of water in a pool, or measuring the depth of any fluid in a conduit.

Measurement and remote representation of fluid levels in these types of applications are well known as diverse. Simple visual indicators, such as “sight tubes”, may be attached to the exterior of a container or tank; and simple mechanical devices, such as floats may be provided in containers, with a mechanical indicator attached to the float, responsive to changes in the position of the float and visible to an operator or observer.

More commonly, electronic sensors are utilized for fluid measurement and monitoring tasks. Again, by way of example, motor vehicle fuel tanks frequently incorporate a sender inserted in the tank, which provides an electrical signal responsive to the position of a float/potentiometer combination mounted within the tank. For many years, these types of float/potentiometer combinations, providing a variable resistance or variable current output were standard equipment in a wide variety of motor vehicles, including aircraft, land vehicles and boats. Such fundamental electronic sensors also found use in fuel, water and oil tanks of a wide description.

It was well known, however, that such electro mechanical sensors suffered from certain limitations. In particular, such electrical mechanical systems utilizing floats involved mounting a float on a slide or pivot mechanism within the fuel tank. Over time, the mechanical interconnection between the float and its associated mechanical components resulted in wear to pivot or slide elements, causing the float mechanism to bind or seize, either intermittently or permanently, rendering the float mechanism inoperative or unreliable. Further, potentiometer-based systems frequently utilize a coil of wire and an associated wiper element, which, over time, would wear due to friction between the wire and the wiper. The wiper arm would actually abrade the wire, resulting in an unreliable electrical connection between the wiper and the coil.

As a result of these limitations, electronic fluid level sensors have been developed which do not rely on moving parts. In particular, capacitance-based sensors have been perfected, which operate by measuring the change in capacitance associated with the varying of level of fluid between a pair of electrodes. It is known that particular fluids, such as gasoline, have a specific dielectric value. When two electrodes are placed in close proximity, they act as a capacitor. Depending on the nature of the material which separates these electrodes, the electrical capacitance of the assembly will vary with the dielectric. Air and gasoline have substantially different dielectric properties, and it is possible to create an electrical circuit which will respond to changes in the dielectric value of the materials separating the electrodes.

In the past, it was common practice to construct fuel tanks which contained fixed electrodes in proximity to one another, and which could be used as the electrodes of a capacitor consisting of the two electrodes and the air or fuel which separated them acting as the dielectric. More recently, Centroid Products developed a removable capacitive fuel sensor, consisting of a pair of concentrically located electrodes, in the form of two concentrically located tubes spaced apart by insulators, and attached to a mount adapted to secure the sensor to a vessel such as a fuel tank. The two concentrically mounted tubes are separated by a known volume of air, which is displaced by fluid as the level of fluid in the vessel in which the sensor is mounted changes. The insulators which separate the inner and outer conductors are designed as a loose fit, thereby allowing fluid from the vessel to rise and fall inside the outer electrode. By measurement of the change in capacitance exhibited by the assembly as the fluid level changes, the level of fluid in the tank can be represented by the change in capacitance.

In this prior art system, the mount for the electrode pair is provided with a plurality of fasteners to allow the sensor to be secured to the outside of the vessel. This type of sensor is typically provided with a calibration circuit, to allow the probe length to be adjusted by trimming to length, and to establish “full” and “empty” limits. A significant drawback to the prior art design, however, is the necessity that the concentric electrodes be of rigid construction. This type of probe is not flexible or bendable, inasmuch as the impartation of a bend to the probe may cause the inner and outer electrodes to short circuit, rendering the probe inoperative. While it is possible to provide full insulation between the inner and outer electrodes to prevent such short circuit, only relatively short lengths of insulation may be reliably incorporated into this type of construction, since the addition of the insulator between the inner and outer electrodes substantially affects the dielectric value of the interior of the probe, due to the substantial insulating properties of the insulator.

A further drawback of the present design is the difficulty in installing the above-described type of rigid probe in a confined space. In a situation where a fluid-containing vessel is surrounded by other components, such as the sheet metal or framework of a motor vehicle, the insertion of a rigid sensor, which may be several inches in length, may be impossible.

It is desirable then, that a fluid level sensor be available which overcomes these limitations.

### SUMMARY OF THE INVENTION

It is an object of the present invention, therefore, to provide for a solid-state fluid level sensor capable of measuring the level of fluid in a vessel without the incorporation of any moving parts.

It is a further object of the present invention to provide a fluid level sensor which may be readily deformed to accommodate variations in fluid vessel geometry.

It is a further object of the present invention to provide for a flexible fluid level sensor which may be readily deformed for purposes of installation in confined spaces, and subsequently returned to a prior non-deformed configuration after the installation of the device is complete.

### DESCRIPTION OF THE DRAWINGS

FIG. 1 is a stylized perspective view of a rigid instruction fuel probe in partial engagement with a typical fuel tank.

FIG. 2 is a side view of a conventional rigid fuel probe mounted in a fuel tank in relation to an obstruction above the fuel tank, and depicting the difficulty presented by the attempted use of a rigid probe in relation to a fuel tank adjacent to an obstruction.

FIG. 3 is a perspective view of the present invention;

FIG. 3A is a detailed cross-section view of the present invention;

FIG. 4 is a side view of a sensor of the present invention being installed in a fuel tank adjacent to an obstruction;

FIG. 5 is a side view of the methodology of inserting the present invention into a fuel tank adjacent to an obstruction; and

FIG. 6 is a collection of drawings of the prior art in several variants.

### DESCRIPTION OF THE PREFERRED EMBODIMENT

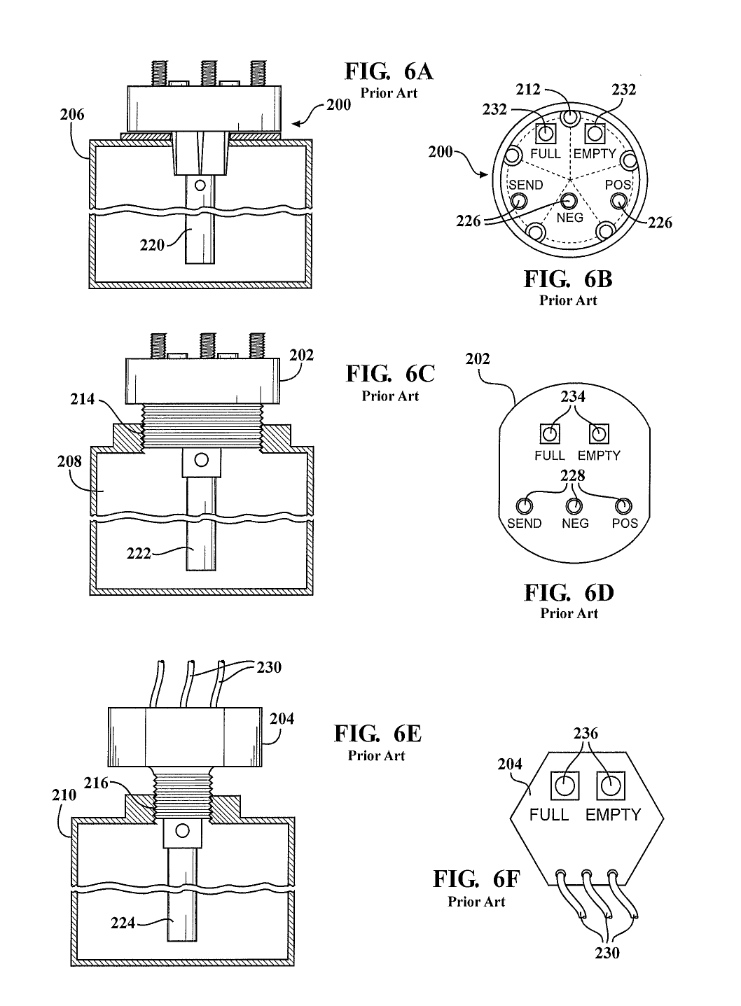

Currently known fluid level transducers, also referred to as fluid level sensors, are depicted in FIG. 6. In a typical installation, the probe head 200, 202, 204 contains a printed circuit board (not shown) with the necessary conversion electronics. The circuit board is generally potted or otherwise permanently sealed within the probe head 200, 202, 204, which may take one of several different forms. A typical form utilizes a circular shaped head provided with mounting components 212 conforming to known industrial standards. Probe heads 200, 202, 204 may also be mounted to fuel tanks 206, 208, 210 using threads 214, 216, also depicted in FIG. 6. In each case, as shown in FIG. 6, fuel probes further comprise a probe element 220, 222, 224, usually in the form of a pair of concentrically located rigid tubes, which extend from the underside of the probe head 200, 202, 204 and are inserted into the tank 206, 208, 210 carrying the fluid to be measured. Electrical connectors in the form of terminals 226, 228 or wires 230 exit the probe head 200, 202, 204 and are used for connection to power supplies and indicators, such as fuel gauges. In addition, calibration adjustments are available 232, 234, 236 to calibrate the sensors. In the art depicted in FIG. 6, fuel probes are not bendable, and insertion of a fuel probe having substantial length requires clearance above the mounting point on the fluid tank so that the probe can be easily inserted.

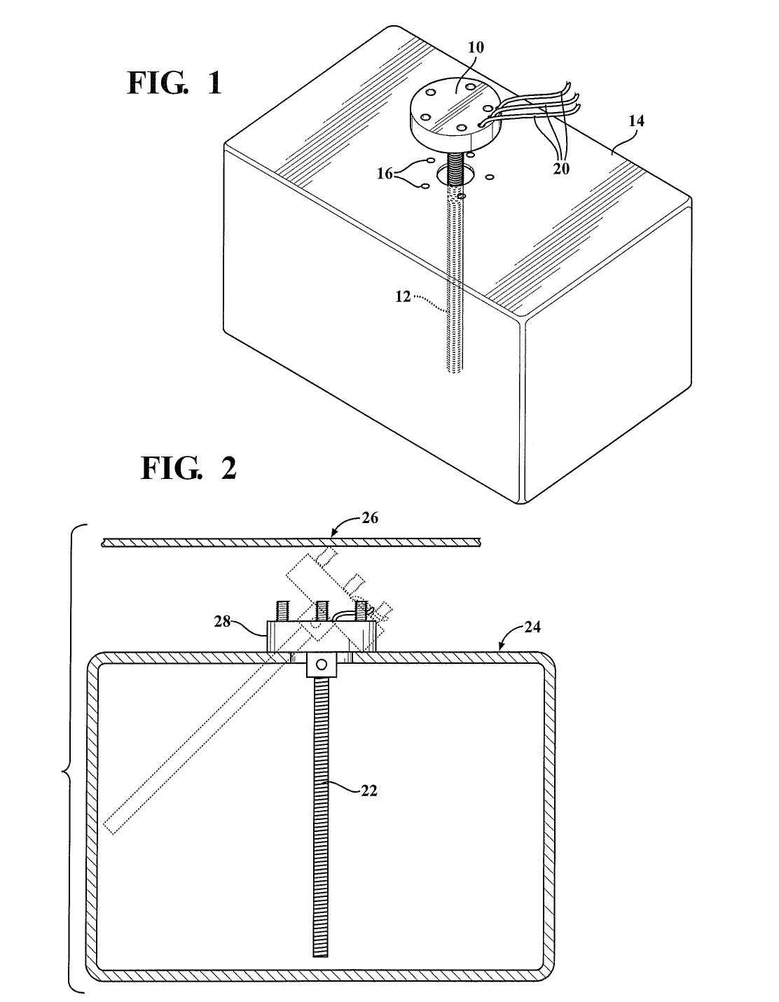

A similar view, in perspective, of the mounting of a fluid level transducer 10 is shown in FIG. 1. In this drawing, it can be seen that a rigid fuel probe 12 attached to a sensor head 18, being a portion of a rigidly assembled fluid level transducer 10, is designed to be attached to the top of a fluid tank 14 utilizing mounting holes 16 and fasteners (not shown) and then operatively connected to a digital or analog gauge (not shown) by wires 20. This configuration works well, so long as there is no impediment to the insertion of the fuel probe in the tank.

With reference now to FIG. 2, the problem addressed by the present invention will be better understood. In this configuration, the fluid probe 22 is intended to be mounted in a tank 24; however, the tank is permanently secured in relation to an obstruction 26 which precludes vertical insertion of the transducer 28 into the tank 24. As shown in the ghost view in the drawing (dotted lines), the obstruction 26 limits the angle at which the probe 22 may be inserted into the tank 24, and may completely prevent insertion of the transducer 28, depending on the dimension between the top of the fuel tank 24 and the obstruction 26.

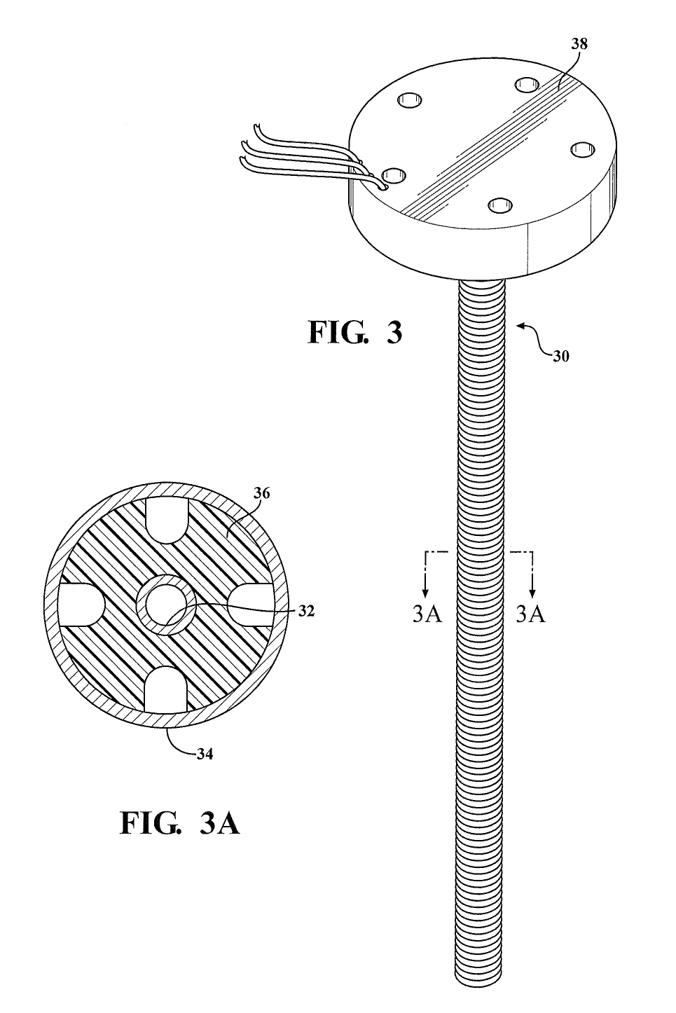

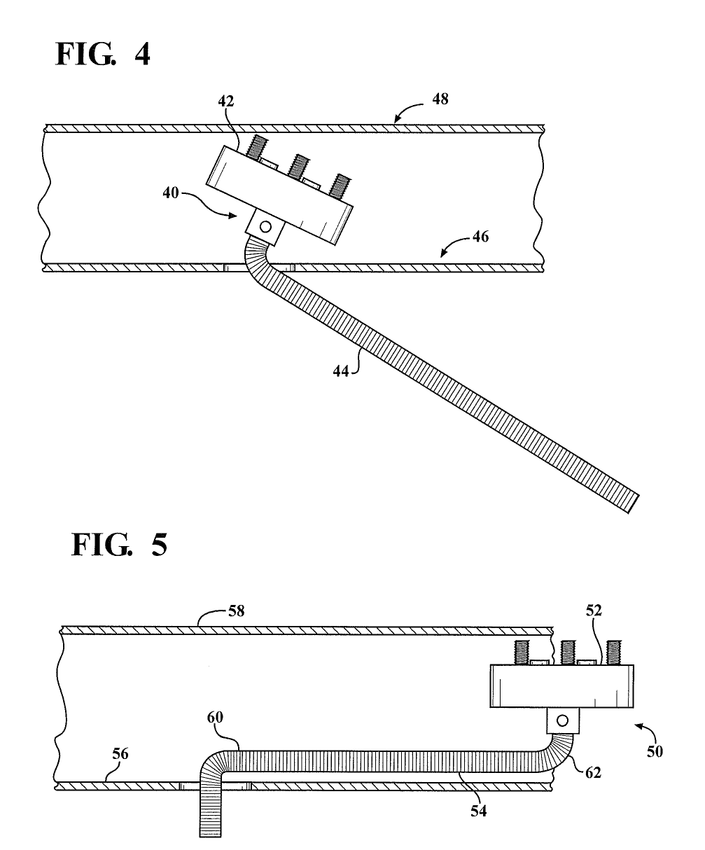

To overcome this limitation, the present invention substitutes springs 30 in place of the rigid fuel probe to be attached to the sensor head 38. Specifically, both the inner 32 and outer conductors 34 as shown in FIGS. 3 and 3A, separated by an insulator 36, are formed of coiled springs. These springs are easily deformable as shown in FIG. 4 and FIG. 5. FIG. 4 shows a flexible fluid level transducer 40 comprising a sensor head 42 and a flexible probe 44 being inserted into a tank 46 in the presence of an obstruction 48. FIG. 4 shows a flexible probe 44 being deformed to be inserted into the tank 46 while avoiding obstruction 48. Once the deformed probe 44 portion of the transducer 40 has been completely inserted in the tank 46, the spring elements are returned to their normal substantially straight configuration, presenting to the fluid within the tank a probe element having a height corresponding to the vertical dimension of the fluid tank. This invention is further easily removable from the tank in case of service requirement, by reversing the process above described. FIG. 5 shows another instance of a flexible fluid level transducer 50 comprising a sensor head 52 and flexible probe 54 being inserted into a tank 56 in the presence of an obstruction 58. In this case, the flexible probe 54 is deformed in two places 60, 62 to permit the flexible probe 54 to be inserted into the tank 56 while avoiding the obstruction 58.

A further advantage of using a flexible probe to measure fluids in a tank is in applications having an irregularly shaped tank, where there may not be enough vertical clearance below the mounting hole to permit a rigid probe to accurately measure the volume of fluid in the tank. A flexible probe would be more likely to usefully extend into the irregular tank to measure the volume of fluid in the tank. Other flexible probes designed to measure irregular volumes may require weights or other ways to anchor the flexible probe in the tank to permit accurate measurements. Embodiments of this invention employ springs as the flexible probe to use the property that springs will try to return to their original configuration as soon as the force that is deforming them is removed. In the case where there is no obstruction in the tank, the spring will return to its original straight configuration. In the case of an irregular tank, the flexible probe will attempt to return to as close to its original configuration (straight) as possible, thereby extending itself to its greatest extent. This will permit reliable, repeatable application of this invention to irregularly shaped tanks. In this case, the conversion electronics may be programmed to provide accurate estimates of fluid in the tank at various levels in spite of irregular geometry in the tank.

Having thus described my invention, numerous obvious modifications may be made thereto without departing from the essence of the invention which I claim as follows:

1. An improved fluid level sensor comprising:
a mounting portion; and,
a probe portion, said probe including a pair of parallel electrodes in proximity, the improvement including the construction of said pair of electrodes from deformable springs.

2. The fluid level sensor of claim 1, wherein said pair of deformable springs are concentrically mounted.

3. The pair of deformable springs of claim 2 wherein said concentrically mounted pair of deformable springs are separated by insulators.

4. The fluid level sensor of claim 1 wherein said deformable springs are operative to deform while being mounted and return to a substantially straight configuration following mounting.

5. The fluid level sensor of claim 1 wherein said deformable spring is operative to deform while being mounted and then conform to an irregularly shaped tank following mounting.

6. A method for measuring the level of fluid in a tank comprising:
inserting a probe into said tank, wherein said probe includes a pair of electrodes constructed from deformable springs;
operatively connecting said probe to a gauge;

7. The method of claim 6, wherein said pair of deformable springs are concentrically mounted.

8. The method of claim 7 wherein said concentrically mounted pair of deformable springs are separated by insulators.

9. The method of claim 6 wherein said deformable spring are operative to deform while being mounted and return to a substantially straight configuration following mounting.

10. The method of claim 6 wherein said deformable spring are operative to deform while being mounted and then conform to an irregularly shaped tank following mounting.
